(19) United States
(12) Patent Application Publication
(10) Pub. No.: US 2018/0171890 A1
(43) Pub. Date: Jun. 21, 2018

(54) Dual Fumigation Homogeneous Charge Compression Ignition (DF-HCCI) Engine

(71) Applicant: COUNCIL OF SCIENTIFIC & INDUSTRIAL RESEARCH, New Delhi (IN)

(72) Inventor: Wittison KAMEI, Dehradun (IN)

(73) Assignee: COUNCIL OF SCIENTIFIC & INDUSTRIAL RESEARCH, New Delhi (IN)

(21) Appl. No.: 15/848,408

(22) Filed: Dec. 20, 2017

(30) Foreign Application Priority Data
Dec. 20, 2016 (IN) 201611043424

(51) Int. Cl. F02D 19/08; F02D 19/06; F02D 41/00; F02B 1/14

(52) U.S. Cl. CPC F02D 19/081; F02D 19/0692; F02M 27/08; F02D 41/0055; F02B 1/14; F02D 19/0649

(57) ABSTRACT

A dual fumigation homogeneous charge compression ignition (DF-HCCI) engine runs on low volatility internal combustion (IC) engine fuel such as diesel in combination with another IC engine fuel, both simultaneously fumigated in engine intake air stream. Both fumigated fuels mix with engine intake air and they are inducted together, at the same time, into engine combustion chamber where homogeneous charge compression ignition combustion takes place. Fumigation of two fuels, in which one fuel has low volatility, is done by a novel dual fuel fumigation system comprising of at least one ultrasonic atomizer. Combustion phasing control is done by varying proportions of fumigated fuels, EGR rate, and EGR temperature and additionally by controlling engine intake air temperature. Engine intake air is controlled to a desirable temperature by heat exchanger utilizing heat from engine and/or exhaust gas. A controller monitors inputs from relevant sensors and, based on these inputs, adjusts fumigation rates of fuels, EGR rates, EGR temperature and engine intake air temperature.

### FIELD OF INVENTION

The present invention relates to an internal combustion (IC) engine of a fumigated homogenous charge compression ignition type with a mixture of air and two different fuels inducted into a combustion chamber and compressed to combust by auto-ignition. The present invention relates particularly to a dual fumigation homogeneous charge compression ignition (DF-HCCI) engine that runs on low volatility IC engine fuel such as diesel in combination with another IC engine fuel, both fumigated in the intake air stream. More particularly, the present invention relates to a DF-HCCI engine that employs fumigation of two fuels, in which one fuel has low volatility, by a fumigation system comprising of at least one ultrasonic atomizer. Combustion phasing control is done by varying proportions of fumigated fuels, EGR rate, EGR temperature and additionally by controlling engine intake air temperature. Engine intake air is controlled to a desired temperature by a heat exchanger utilizing heat from the an engine and/or exhaust gas. A controller monitors inputs from relevant sensors and, based on these inputs, adjusts fumigation rates of fuels, EGR rates, EGR temperature and engine intake air temperature.

### BACKGROUND OF THE INVENTION AND DESCRIPTION OF PRIOR ART

Homogeneous charge compression ignition (HCCI) engines have been widely studied throughout the world. In HCCI engines, HCCI combustion takes place by auto ignition of homogeneous charge and, therefore, preferably requires high cetane fuels such as diesel. However, high cetane fuels such as diesel are mostly low volatility fuels. The difficulty of low volatility fuel to vaporize and form homogeneous charge with engine intake air is one of the major challenges of HCCI engine. Difficulty in combustion phasing control at different engine operating conditions is another major problem faced by HCCI engines. Certain HCCI engines use two fuels and reactivity of charge is adjusted by varying proportions of the two fuels so as to control the combustion phasing. Such fuel reactivity control extends the range of operation for HCCI engines.

In HCCI engine, fuel reactivity control strategies with fumigation of two different fuels have been reported in the literature. However, this is generally limited to fumigations where the fuels are readily volatile or in gaseous form. Reference may be made to an article in SAE paper No. 2004-28-002, 2004 by Nagarajan et al. where they used fumigation of two volatile fuels i.e., gasoline and diethyl ether for reactivity control in HCCI engine. Reference may also be made to article in the International Journal of Automotive Technology 15(4): 517-523, 2014 by Vinayagam and Nagarajan where they used fumigation of two volatile fuels i.e., diethyl ether and ethanol in a HCCI engine using electronic fuel injectors. Reference may also be made to an article in SAE paper No. 2004-28-0020, 2004 by Nagarajan et al. where they used fumigation of two volatile fuels i.e., LPG and diethyl ether for reactivity control in HCCI engine. However, as mentioned earlier, the fumigation of two fuels for reactivity control, as reported in the literature, has been limited only to the volatile fuels. Fumigation systems used for fumigation of two fuels for HCCI combustion, as reported in the literature, are limited to be suitable only for a combination of fuels which are volatile such as gasoline, alcohol, LPG etc. The present invention overcomes this limitation and utilizes fumigation of low volatility fuel such as diesel in combination with another fuel for HCCI combustion.

Fuel reactivity control is used in certain engines by introducing two different fuels into the combustion chamber at different times to produce stratified regions that will auto-ignite under compression. Reference may be made to US patent No. US 2014/0026859 A1, 2014 by Gehrke et al. where they mentioned a Reactivity Controlled Compression Ignition (RCCI) engine with EGR which is configured to utilize a RCCI process and an EGR. The engine by Gehrke et al. is adapted to introduce two different fuels of different reactivity at different times during the intake-compression cycle of the engine. In the invention by Gehrke et al., a controller adjusts the EGR and/or the second introduction of the second fuel charge. Reference may also be made to U.S. Pat. No. 8,616,177 B2, 2013 by Reitz et al. where they use fuel reactivity stratification to control engine combustion where a lower-reactivity fuel charge is injected or otherwise introduce into the combustion chamber, preferably sufficiently early that it becomes at least substantially homogeneously dispersed within the chamber before a subsequent injection is made; one or more subsequent injections of higher-reactivity fuel charges are then made. In the above inventions by Reitz et al. (U.S. Pat. No. 8,616,177 B2) and Gehrke et al. (US 2014/0026859 A1), the fuels are injected or introduced into the combustion at different times. Further, there have been reports on vaporization of low volatility fuel using a heated chamber or hot EGR. Reference may be made to U.S. Pat. No. 6,923,167 B2, 2005 by Daniel L. Flowers where hot EGR is explained to be used for vaporization of low volatility fuel. Reference may also be made to an article in Applied Energy 99:116-125, 2012 by A. P. Singh and A. K. Agarwal where they explained the use of a heated chamber for vaporization of diesel for HCCI combustion.

Reference may be made to an article in SAE paper 910667, 1991 by Tsurutani et al. where they used an ultrasonic atomizer in SI engine for atomizing diesel at the intake of 499 cc twin cylinder 2-stroke SI outboard motor engine. In this, a wall wetting of an inlet channel was greatly reduced. With the ultrasonic atomization of diesel, it was feasible for them to run the 2-stroke SI engine with diesel fuel. Reference may also be made to an article in SAE paper 920691, 1992 by Ohkoshi et al. where they used an ultrasonic atomizer for fumigation of gasoline at the intake manifold of a commercial four cylinder diesel engine in order to achieve diesel smoke reduction. Reference may also be made to U.S. Pat. No. 6,450,154 B1, 2002 by C. Y. Choi where a piezoelectric oscillator in the combustion chamber of an HCCI engine to generate ultrasonic pressure waves to enhance fuel droplets breakup.

### Objectives of the Invention

The main objective of the present invention is to provide a dual fumigation homogenous charge compression ignition engine (DF-HCCI) that runs on low volatility IC engine fuel such as diesel in combination with another IC engine fuel, both fumigated in engine intake air. Both fumigated fuels mix with air and they are inducted together at the same time into a combustion chamber by a suction stroke. At engine intake air stream, low volatility fuel is fumigated by ultrasonic atomizer while another fuel is injected or inducted.

Another objective of the present invention is to provide a DF-HCCI engine configured to utilize fumigation of two fuels at engine intake air stream in a way mentioned above along with exhaust gas recirculation and additionally engine intake air temperature control for combustion phasing control. Engine intake air is controlled to a desirable temperature by a heat exchanger utilizing heat from the engine and/or exhaust gas. Fuel reactivity control and thereby combustion phasing control at different engine operating conditions is done by adjusting proportions of fumigated fuels, in which one fuel has low volatility, and further by varying amount and temperature of EGR.

Still another objective of the present invention is to provide a DF-HCCI engine capable of operating over a wide range of loads and speeds.

Yet another objective of the present invention is a DF-HCCI engine configured as mentioned in the above objectives but not only limited for low volatile fuel and high volatile fuel combinations but also suitable for a combination of fuels of any volatility.

### SUMMARY OF THE INVENTION

In an aspect of the present invention, the disclosure describes an internal combustion engine system utilizing a dual fumigation, an EGR and an engine intake air temperature control and an HCCI combustion process. The engine is referred here as dual fumigation homogeneous charge compression ignition engine (DF-HCCI).

In accordance with an embodiment of the present invention, the DF-HCCI engine comprises: an engine body, at least one combustion chamber in said engine body having a piston reciprocating in a cylinder, an engine intake air system to intake an air stream and deliver it to the at least one combustion chamber, an engine exhaust system to direct exhaust gases from the at least one combustion chamber, a first fuel delivery system to fumigate and supply a first fuel into the air stream, and a second fuel delivery system to fumigate and supply a second fuel into the air stream, wherein the engine intake air system is adapted to form a homogeneous mixture of the air stream, the first fuel, and the second fuel for combustion in at least one combustion chamber.

Further, in said embodiment, the first fuel delivery system comprises an ultrasonic atomizer for atomizing the first fuel having a low volatility and delivering the low volatility first fuel into said engine intake air system and the second fuel delivery system comprises an electronic injector or an ultrasonic atomizer or any fuel induction system for delivering a second fuel into said engine intake air system. Furher, the first fuel is a low volatile fuel such as diesel and the second fuel is a high volatile fuel or a gaseous fuel.

Further, in said embodiment, the first fuel and the second fuel are supplied into the air stream at the same time or at predefined timings to form the homogeneous mixture.

Further, in said embodiment, the engine intake air system comprises an intake air heating apparatus to control temperature of the air stream by utilizing heat from exhaust gas and/or the DF-HCCI engine.

Further, in said embodiment, the DF-HCCI engine further comprises an engine exhaust system to guide exhaust gases from the at least one combustion chamber.

Further, in said embodiment, the DF-HCCI engine further comprises an exhaust gas recirculation (EGR) system to recirculate a portion of engine exhaust gas. The EGR system comprises: an EGR flow control valve in communication with a flow control valve driver to regulate flow rate of the EGR into the air stream, and an EGR coolant fluid flow control valve in communication with a fluid flow control valve driver to control temperature of the EGR flowing through an EGR heating unit.

Further, in said embodiment, the DF-HCCI engine further comprises an electronic control unit to receive inputs from a plurality of sensors and transmit control signals to control fuel flow rate, EGR rate, EGR temperature, and air stream temperature. Further, in said embodiment, the DF-HCCI engine further comprises the plurality of sensors comprises one or more of temperature sensors, engine speed sensors, engine shaft crank angle sensors, and engine load sensors.

Further, in said embodiment, the DF-HCCI engine is adapted to control a combustion phase at least by varying proportions of the first fuel, the second fuel, the EGR rate, the EGR temperature, and the air stream temperature.

In accordance with another embodiment of the present invention, a method is provided to operate Dual Fumigation Homogeneous Charge Compression Ignition (DF-HCCI) Engine. The method comprising: supplying an air stream for combustion using an engine intake air system, fumigating and supplying a first fuel and a second fuel into the air stream using a first fuel delivery system and a second fuel delivery system respectively, mixing the air stream, the first fuel, and the second fuel to form a homogeneous mixture, and supplying the homogeneous mixture to at least one combustion chamber for combustion.

Further, in said embodiment, the method further comprises: controlling supply of the first fuel and the second fuel based at least on engine load and engine speed in order to achieve required combustion timing in a combustion phase, controlling an EGR rate and an EGR temperature based at least on the engine load and the engine speed, and heating the air stream to a required temperature using an intake air heating apparatus.

In another aspect, the disclosure describes a DF-HCCI engine with combustion phasing control done by a combined strategy of varying proportions of the two fumigated fuels and varying the EGR rate and the EGR temperature and additionally by controlling the engine intake air temperature. Fumigation of two fuels, in which one fuel has low volatility, is performed by a dual fuel fumigation system of the present invention that comprises at least one ultrasonic atomizer. Further, the scope of the invention is not intended to be limited to the particular forms disclosed. The invention covers all equivalents, modifications, and alternatives falling within the scope and spirit of the invention as defined by the claims.

### BRIEF DESCRIPTION OF DRAWING

FIG. 1 shows a schematic diagram of one embodiment of an engine system, in accordance with the present disclosure, showing a single cylinder of the engine, dual fuel storage and delivery systems, EGR system, engine intake air heating system and associated control system;

FIG. 2 shows a block diagram for engine controller in accordance with the disclosure of the present invention;

FIG. 3 shows a schematic diagram of one embodiment of exemplary version of the present invention, in accordance with the disclosure of the present invention, showing a single cylinder of the engine, dual fuel storage and delivery systems, EGR system, engine intake air heating system and associated control system for DF-HCCI engine that operates on diesel fuel and liquefied petroleum gas.

### DETAILED DESCRIPTION OF THE INVENTION

It is difficult to use low volatility fuel such as diesel for homogeneous charge compression ignition mode of combustion, given the difficulty to vaporize such fuel. It is also difficult to control combustion phasing in homogeneous charge compression ignition mode of combustion. The engine of the present invention uses low volatility fuel such as diesel in combination with another fuel for homogeneous charge compression ignition mode of combustion. Fumigation of two fuels, in which one fuel has low volatility, is performed by a dual fuel fumigation system comprising of at least one ultrasonic atomizer. Combustion phasing control is done by a combined approach which varies proportions of two simultaneously fumigated fuels, EGR rate, and EGR temperature and additionally controls engine intake air temperature. Such combined approach of combustion phasing control using the ultrasonic atomizer and where one fuel is a low volatility fuel is not known by prior arts or by literature.

The present invention relates to an internal combustion engine of a fumigated homogenous charge compression ignition type that operates on two fuels, in which one fuel has low volatility. Both fuels are fumigated simultaneously in the engine intake air stream by a novel dual fuel fumigation system comprising of at least one ultrasonic atomizer. The DF-HCCI engine overcomes the difficulty faced by HCCI mode of combustion to utilize fumigation of low volatility fuel such as diesel in dual fuel mode along with other fuel. Low volatility fuels in the context of the present invention refer to those liquid fuels which are not readily vaporized by fuel injector equivalent to low pressure gasoline fuel electronic injector typically used in present day vehicles. The dual fuel fumigation system comprises a pair of fuel delivery systems, for example, first fuel delivery system and second fuel delivery system. One of the fuel delivery systems has an ultrasonic atomizer and the other fuel delivery system has an electronic injector or ultrasonic atomizer or any suitable fuel induction system. Both the fuels are simultaneously fumigated into the engine intake air stream or engine intake air. Both fumigated fuels mix with the engine intake air and they are inducted together, at the same time, into engine combustion chamber where homogeneous charge compression ignition takes place. Said dual fuel fumigation system uses a pair of ultrasonic atomizer systems for fumigation of both fuels, continuous dual fuel fumigation strategy is used. In the continuous dual fuel fumigation strategy, both fuels are continuously fumigated by the ultrasonic atomizer systems. Said dual fuel fumigation system uses ultrasonic atomizer system for fumigation of low volatility fuel and electronic liquid or gaseous fuel injector system for fumigation of the other fuel, timed dual fuel fumigation strategy is used. In the timed dual fuel fumigation strategy, low volatility fuel is continuously fumigated by the ultrasonic atomizer system and the other fuel is injected at suitable timing by the electronic injector system such that best possible mixing of both fuels with intake air is achieved. The meaning of simultaneous fumigation of two fuels, in the context of the present invention, covers such timed dual fuel fumigation strategy also. Further, in the context of the present invention, the meaning of both fuels mixing with intake air and getting inducted together at the same time also covers induction of fuels and air mixture to combustion chamber resulting from such timed dual fuel fumigation strategy. In the DF-HCCI engine of the present invention, combustion phasing control is done by varying proportions of fumigated fuels, EGR rate, and EGR temperature and additionally by controlling engine intake air temperature. The engine intake air is controlled to a desirable temperature by a heat exchanger utilizing heat from the engine and/or engine exhaust gas. A controller monitors inputs from relevant sensors and, based on these inputs, adjusts fuels fumigation rates, EGR rates, EGR temperature and also the intake air temperature. The engine intake air stream or engine intake air can be used interchangeably.

The DF-HCCI engine system includes an engine body with a combustion chamber. The combustion chamber has a piston reciprocating in a cylinder for the different strokes associated with the HCCI mode of combustion. The engine system in accordance with the present invention includes a dual fuel fumigation system comprising of at least one ultrasonic atomizer for fumigation of two fuels, in which one fuel has low volatility. Both fumigated fuels mix with engine intake air and they are inducted together, at the same time, into engine combustion chamber where homogeneous charge compression ignition combustion takes place. The engine system further includes an intake manifold and an exhaust manifold to direct engine intake air to the combustion chamber and to direct the combustion products out from the combustion chamber respectively. The engine system also includes an engine intake air heating and control system utilizing heat from the engine and/or engine exhaust gas. The engine system further includes an exhaust gas recirculation (EGR) system which recirculates a portion of the engine exhaust gas to the engine intake air with a control system to control the temperature and the amount of the EGR. The engine also includes sensors monitoring engine operating parameters and multiple temperature signals and a controller controlling fuelling rates, EGR rate and temperature and intake air temperature.

In the present invention, the fumigation of low volatility fuel by ultrasonic atomizer and the fumigation of another fuel by injection or induction or ultrasonic atomizer would be utilized in a DF-HCCI engine so that diesel or any other low volatility fuel can be fumigated with another fuel and the mixture of air and the two fuels inducted together at the same time into the combustion chamber for HCCI combustion. The fuel reactivity control and thereby the combustion phasing control at different engine operating conditions is done by adjusting the proportions of fumigated fuels and further by varying the amount and temperature of EGR. Intake air is also controlled to a desirable temperature through a heat exchanger utilizing heat from the engine and/or exhaust gas.

The DF-HCCI engine of the present invention is configured to induct two fuels together at the same time into the combustion chamber by the suction stroke, one of the fuels being a low volatility fuel such as diesel. As mentioned earlier, low volatility fuel such as diesel is difficult to fumigate in the engine intake air stream. Diesel can be atomized to very fine particles by the ultrasonic atomizer. More particularly, the fumigation of diesel or other low volatility fuel by the ultrasonic atomizer and the fumigation of another fuel by injection or induction or any suitable technique both at the intake air stream, so that the mixture of air and the two fuels are inducted together at the same time into the combustion chamber by the suction stroke for HCCI combustion and further with control of EGR rate and temperature and also control of intake air temperature, has not been reported so far.

The present invention differs from the known solutions in that, in the DF-HCCI engine, fuels of two different reactivity's, of which one fuel has low volatility, are not injected at different times but they are fumigated and inducted together at the same time into the combustion chamber by the suction stroke for HCCI combustion. Further, the DF-HCCI engine is configured to utilize low volatility fuel such as diesel in combination with another fuel.

The fumigation of diesel by ultrasonic atomizer along with fumigation of another fuel by injection or induction at the intake air stream so that both fuels and air mixture is inducted together at the same time into the combustion chamber of an HCCI engine is not disclosed by known arts. Particularly, a combustion phasing control in HCCI using fuel reactivity control by fumigation of two fuels which comprise of (i) diesel or other low volatility fuel fumigation by ultrasonic atomizer and (ii) fumigation of another fuel by injection or induction or any suitable technique so that mixture of air and both fuels is inducted together at the same time into the combustion chamber of the DF-HCCI engine is not disclosed by known arts.

The present invention ensures that an ultrasonic atomizer has been used for fumigation of low volatility fuel at intake air stream in HCCI engine and, particularly, in the configuration and method of the present invention.

The present invention ensures simultaneous dual fuel fumigation with at least one ultrasonic fuel atomizer for fumigating two fuels, in which one fuel has low volatility, for HCCI combustion. Further, in the present invention, HCCI combustion phasing control is performed by a combined strategy of varying fumigation rates of two fuels, in which one fuel has low volatility, by dual fuel fumigation system having at least one ultrasonic atomizer and varying EGR rate and EGR temperature.

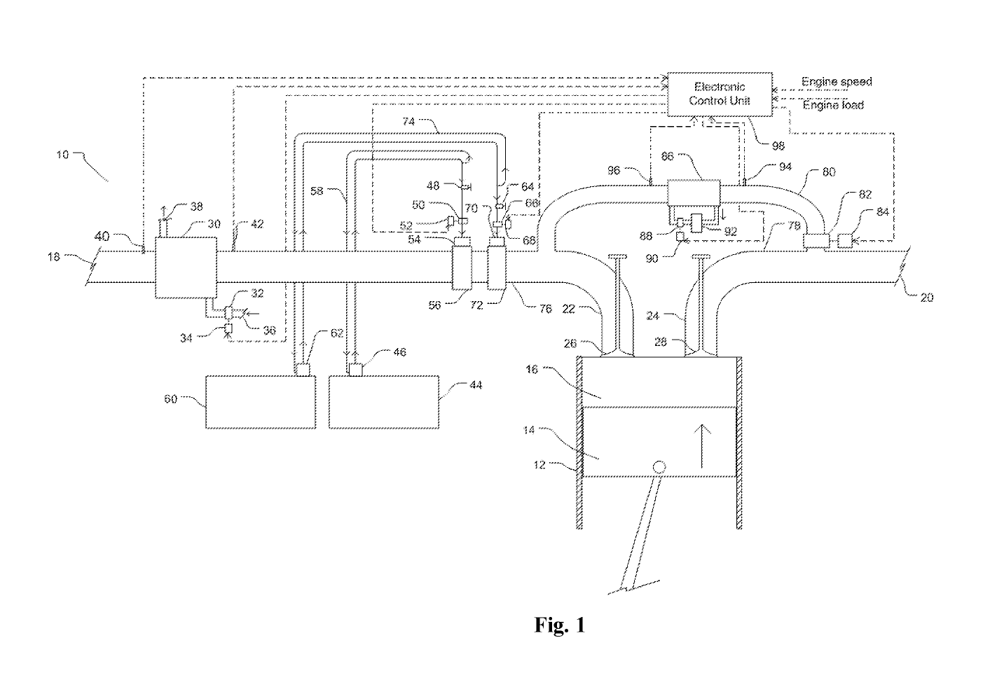

In accordance with an embodiment of the present invention, FIG. 1 shows a schematic diagram of a single cylinder of an engine. The engine 10 has an engine body 12 within which a piston assembly 14 reciprocates. A combustion chamber 16 is formed by the piston assembly 14 and the engine body 12 in a manner well known in the art of internal combustion engine design. In the illustrated embodiment, intake air is directed into the combustion chamber 16 by an intake system 18 which includes an intake port 22 and an intake manifold 76. Engine exhaust gas is directed by an engine exhaust system 20 which includes an exhaust port 24 and an exhaust manifold 78. Intake of fuel-air mixture to the combustion chamber 16 and exhaust of burnt gases from the combustion chamber 16 take place through an intake valve 26 and an exhaust valve 28 respectively. The opening and closing timings of the intake valve 26 and the exhaust valve 28 can either be fixed or variable through a mechanical system or an electronically controlled system in manners well known in the art of modern internal combustion engine design. The intake system 18 also includes an intake air heating system 30 which preheats the intake air depending upon engine requirements. Intake air heating system 30 utilizes heat from the engine and/or exhaust gas. A hot fluid carrying heat from an engine and or exhaust gas enters and leaves the intake air heating system 30 through a hot fluid inlet system 36 and a hot fluid outlet system 38 respectively. The hot fluid inlet system 36 comprises a flow control valve 32 and a flow control valve driver 34. Temperature sensors 40 and 42 are positioned to monitor temperature upstream and downstream of the intake air heating system 30. Alternatively, the intake air heating can be done by the heat exchanger directly utilizing the hot engine exhaust gas. An exhaust gas recirculation (EGR) system 80 recirculates a portion of the engine exhaust gas. An EGR flow control valve 82 and a flow control valve driver 84 regulate a flow rate of EGR into the engine intake air. An EGR coolant fluid flow control valve 88 along with a driver 90 controls temperature of EGR flowing through an EGR heat exchanger 86. The EGR Coolant fluid is cooled in an EGR coolant fluid system 92 which is comprised of an EGR coolant pump and a coolant heat exchanger of any suitable type. In another embodiment, an EGR temperature may also be controlled by a fan which blows air to the EGR heat exchanger 86.

In the illustrated embodiment, fuel storage systems 44 and 60 are used to store fuels for the DF-HCCI engine 10. The fuel supply systems 46 and 62 pump fuels and/or regulate the pressure of fuels. Valves 48 and 64 shut off or open to control delivery of fuels for engine combustion. Flow control valves 50 and 66 along with flow valve drivers 52 and 68, as shown in FIG. 1, regulate flow rates of fuels to an ultrasonic fuel atomizer system 54 and an ultrasonic fuel atomizer system 70 for engine combustion. In the illustrated embodiment, the ultrasonic fuel atomizer system 54 is used for low volatility fuel such as diesel and the ultrasonic fuel atomizer system 70 can also be used for another liquid fuel. The ultrasonic fuel atomizer systems 54, 70 fumigates the fuels into air-fuel mixing chambers 56 and 72 where mixing of the intake air and the fumigated fuels take place. The air-fuel mixing chambers 56 and 72 may have an optimized design for optimum air-fuel mixing and, if required, may be heated by suitable means. Further, for low volatility fuel, the air-fuel mixing chamber may have a fuel collection and a drainage system for a portion of fuel, if any, which is not vaporized. Such collected and drained portion of the fuel may be recirculated for fumigation. Fuel return lines 58 and 74 are provided so that excess fuels either return to the fuel storage systems 44 and 60 respectively or to inlets of fuel supply systems 46 and 62 respectively.

The illustrated embodiment also includes an electronic control unit (ECU) 98 which receives inputs from sensors such as those of temperature, engine speed, crank angle and sensors related to engine load, as shown in FIG. 1, and processes the sensors inputs and provides control signals to drivers such as 34, 52, 68, 84 and 90.

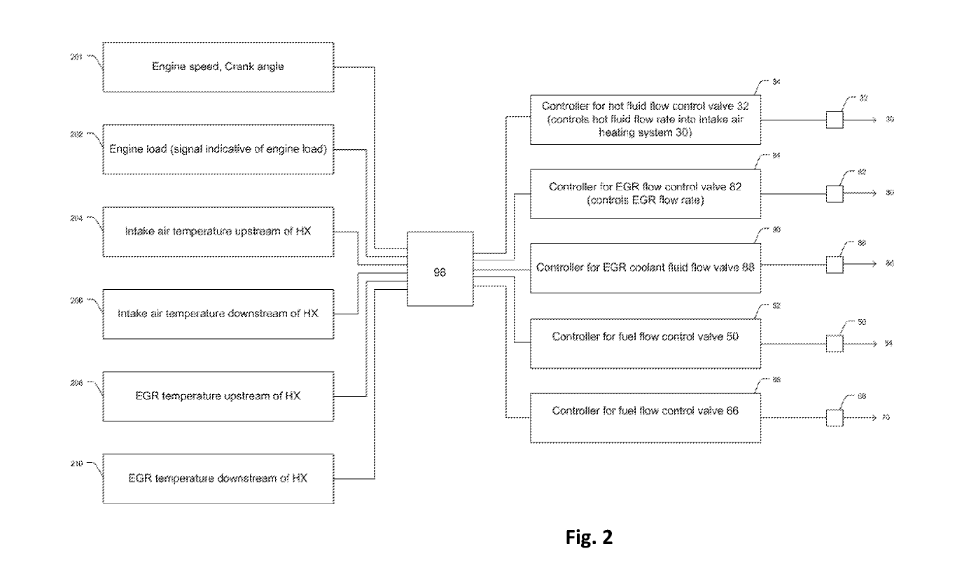

FIG. 2, in accordance with an embodiment of the present invention, shows a block diagram showing some of the inputs to an ECU 98. The ECU 98 is designed to receive sensor inputs indicative of engine operating parameters such as engine speed and load and also inputs from other sensors such as those of temperature. In the block diagram of FIG. 2, the ECU 98 is shown providing a control signal to a plurality of drivers 34, 52, 68, 84 and 90 and the plurality of drivers 34, 52, 68, 84 and 90 in turn control valves 32, 50, 66, 82 and 88 respectively. In FIG. 2, heat exchanger is referred as HX. Sensors indicative of engine operating parameters such as load and speed are not shown in the illustrated embodiment in FIG. 1, and it should be noted that such sensors can be located and fitted in a manner well known to the art of the use of such sensors for internal combustion engines and automotive vehicles.

In the embodiment of the present invention shown in FIG. 1, two fuels are configured to be continuously fumigated into engine intake air stream where the fumigation system 54 is ultrasonic atomizer system for low volatility fuel and fumigation system 70 is also ultrasonic atomizer system for high volatility liquid fuel. However, the present invention covers variants of this configuration where fumigation system 70 is electronic liquid fuel injector or electronic gaseous fuel injector or gaseous fuel-air mixture. However, in all variants of the present invention, fumigation system 54 shall always be ultrasonic atomizer system. In variants where fumigation system 70 is electronic liquid fuel injector or electronic gaseous fuel injector, fuel flow control valve 66 and its driver 68 are not required and injection of fuel is done by the electronic fuel injector at suitable engine shaft crank angle position as determined by the ECU 98 based on the sensors inputs such as those of engine operating parameters and engine shaft crank angle position. In variants where fumigation system 70 is electronic gaseous fuel injector, fuel return line 74 is not required and fuel flow control valve 66 and its driver 68 are replaced by gaseous fuel pressure reducer and fuel supply system 62 is replaced by a solenoid valve to open and close fuel supply. Additionally, for gaseous fuel which is compressed and stored as a liquid in fuel cylinder 60, additional vaporizer system to vaporize liquefied gas en-route to fuel injector can be used as explained in the subsequent section on the exemplary engine of the present invention.

In the embodiment of the present invention shown in FIG. 1, the ECU 98 provides control signals to the drivers 52 and 68 of the fuel flow control valves 50 and 66 depending upon sensor inputs such as those of the engine operating parameters thereby controlling fuel flow rates to the ultrasonic atomizer system 54 and the ultrasonic atomizer system 70. The ultrasonic atomizer systems 54 and 70 comprise a driver, an ultrasonic generator, and an ultrasonic atomizer. A ratio of two fuels delivered through ultrasonic atomizer systems 54 and 70 are computed by the ECU 98 such that fuel reactivity is suitable for correct combustion phasing control at a given speed and load. The ultrasonic atomizer system 54 atomizes a low volatile fuel, thereby making it possible to use a combination of one fuel with low volatility with another volatile fuel or gaseous fuel. The low volatile fuel generally has high cetane number while high volatility or gaseous fuel has generally high octane number. Therefore, The DF-HCCI engine 10 has benefits of fuel reactivity control using the low volatile fuel and the highly volatile fuel. However, it should be noted that the present invention may also be utilized for a combination of fuels which are both having the low volatility or which are both having the high volatility. For the combination of the fuels both having the low volatility, two ultrasonic atomizers will always be used. In FIG. 1, delivery of two fuels are shown at the intake manifold, however, two fuels can also be delivered at the intake port or one fuel can be delivered at the intake port while another fuel can be delivered at the intake manifold. For the DF-HCCI engine configuration having more than one engine cylinder, dual fumigation can be performed for every cylinder or common dual fumigation system can be used for multiple cylinders.

Depending on temperatures of the engine intake air and the engine operating parameters such as load and speed, the ECU 98 provides control signals for fuel flow rates of two fuels to get suitable fuel reactivity while at the same time it also provides control signals for controlling EGR rate and EGR temperature and the engine intake air temperature control. The ECU 98 may also utilize other sensors inputs which additionally provide information to better compute control signals. For example, when intake air temperature is low and engine is operating at specific speed and load, the ECU 98 is configured to control auto-ignition ignition timing by providing control signals corresponding to specific flow rates of two fuels and also provide control signal corresponding to specific EGR temperature and EGR flow rate and the engine intake air temperature. Therefore, the combustion phasing control is achieved by controlling parameters such as the fuel reactivity, EGR flow rate, EGR temperature and engine intake air temperature. Further, it should be noted that fuel reactivity control can be done for the combination of the fuel with low volatility such as diesel with another fuel of any volatility or combination of any two fuels of any volatility.

The illustrated embodiment as shown in FIG. 1 has only one cylinder. However, it should be noted that the present invention may be utilized in internal combustion engines having one or more cylinders and having a four-stroke or a two-stroke configurations. Further, the present invention is specifically with reference to using an ultrasonic atomizer for a low volatility fuel atomization. However, any suitable system may also be utilized for atomization of the low volatility fuel and high volatility fuel or gaseous fuel.

The present DF-HCCI engine may be used for any stationary or non-stationary applications such as power generation, agriculture, and automotive engines. The definition of fuel in the DF-HCCI engine is not restricted to only fuels but it also encompasses chemicals or any such compound, used in any suitable quantity, which can be used for combustion or which can affect combustion. The DF-HCCI engine operates in dual fuel mode, however, at some operating points of the engine, only one fuel may be used for combustion. In the present invention, the combustion phasing control is done by varying proportions of the fumigated fuels, EGR rate and EGR temperature and additionally by varying engine intake air temperature. Of the four parameters, i.e., varying proportions of the fumigated fuels, varying EGR rate, varying EGR temperature and varying engine intake air temperature, any one of them or combination of them or all of them can be employed depending on engine requirements.

### DETAILED DESCRIPTION OF EXEMPLARY VERSION OF THE INVENTION

The following example is given by way of illustration of the present invention and should not be construed to limit the scope of the present invention. Following is a brief summary of the exemplary version of the invention.

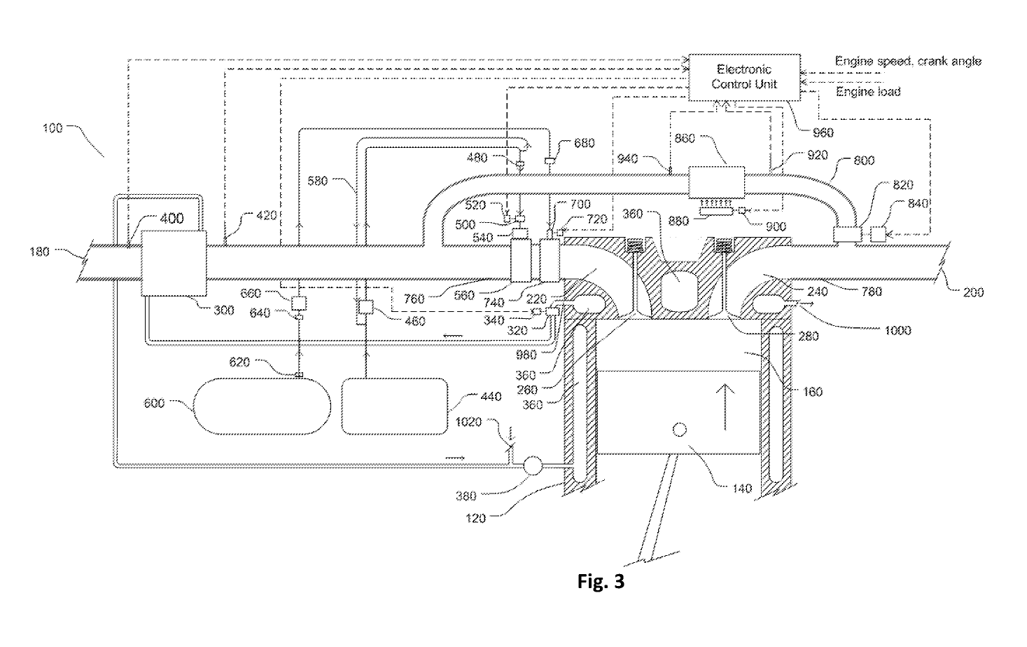

FIG. 3 shows the schematic view of an exemplary dual fuel homogeneous charge compression ignition engine of the present invention. The exemplary version is for a diesel fuel and a liquefied petroleum gas (LPG). An engine 100 has an engine body 120 within which a piston assembly 140 reciprocates. The piston assembly 140 and the engine body 120 forms a combustion chamber 160 in a manner well known in the art of internal combustion engine design. An engine intake air is directed to the combustion chamber 160 by an engine intake air system 180. The engine intake air system 180 is primarily comprised of an intake port 220, an intake manifold 760 and an intake air heating system 300. An engine exhaust gas is directed by an exhaust system 200 which includes an exhaust port 240 and an exhaust manifold 780. An intake of an fuel-air mixture to the combustion chamber 160 and exhaust of burnt gas from the combustion chamber 160 take place through an intake valve 260 and an exhaust valve 280 respectively. The closing and opening timings of the intake valve 260 and exhaust valve 280 are fixed and controlled through a mechanical system in a manner well known in the art of internal combustion engine design. An intake air heating system 300 is a heat exchanger with hot water (engine coolant) from the engine body 120 as hot fluid and engine intake air as a cold fluid. A flow rate of hot water to the intake air heating system 300 is controlled by a flow control valve 320. The flow control valve 320 is controlled by an electronic control unit (ECU) 960 through a flow control valve driver 340. The hot water flow rate is controlled to get desirable intake air temperature downstream of the intake air heating system 300. Temperature sensors 400 and 420 are positioned to monitor temperature upstream and downstream of the intake air heating system 300. The engine body 120 has coolant circulation galleries 360 around the combustion chamber 160 for circulation of engine coolant to maintain the engine body 120 within the desired temperature and to prevent the engine body 120 from overheating. In the present exemplary DF-HCCI engine, water is used as the engine coolant. However, in the DF-HCCI engine of the present invention, any other suitable coolant can be used.

In the exemplary DF-HCCI engine of the present invention, hot water from the engine body 120 has two outlets. A first hot water outlet 980 is for circulating water to the intake air heating system 30 and a second hot water outlet 1000 is for circulating hot water to an engine radiator system for cooling of the hot water. The engine radiator system is a heat exchanger system for cooling engine coolant comprising components and accessories such as a thermostat, valve, hose pipes, fan controlled by electronic controlled unit, heat exchanger etc., integrated together in a manner well known in the art of internal combustion engine design and vehicle design. For the sake of simplifying the illustrated drawings, the engine radiator system is not shown in the present embodiment. A hot engine coolant circulation both through the intake air heating system 300 and the radiator system is accomplished by an engine coolant pump 380. An engine coolant from a radiator is circulated through inlet 1020 by the engine coolant pump 380. In the exemplary DF-HCCI engine, an exhaust gas recirculation (EGR) system 800 recirculates a portion of an engine exhaust gas. An EGR flow control valve 820 and a flow control valve driver 840 regulate a flow rate of the EGR into the engine intake air. In the present exemplary DF-HCCI engine, an EGR temperature is controlled by a fan 880 which blows air to the EGR heat exchanger 860. The ECU 960 controls operation of a fan 882 through a fan driver 900 so as to get the desired EGR temperature downstream of the heat exchanger 860. Temperature sensors 920 and 940 are positioned to measure the EGR temperature upstream and downstream of the heat exchanger 860.

In the exemplary engine of the present invention, the liquefied petroleum gas (LPG) is stored and supplied from a fuel cylinder 600. Solenoid valves 620 and 640 control the opening and closing of a fuel supply. The Liquefied petroleum gas is vaporized at a vaporizer 660. The pressure of gas downstream of the vaporizer 660 is reduced by a pressure reducer 680 and the gas is finally injected by an electronic injector 700. An additional solenoid shut-off valve, not shown in the illustrated drawing, may also be used before the electronic injector 700. A gas injection duration per combustion cycle and a gas injection timing are provided by the ECU 960 to the injector driver 720. Another fuel tank 440 is provided that stores and supplies fuel of low volatility, which is diesel in the exemplary DF-HCCI engine of the present invention. The diesel supply is done by a fuel pump 460. A diesel flow control valve 500 controls flow rate of diesel to ultrasonic atomizer system 540. The ultrasonic atomizer system is explained in more detail elsewhere in this document. A fuel shut-off valve 480 stops fuel supply to the ultrasonic atomizer system 540 when the engine is not running. A fuel return line 580 feeds back excess diesel to an inlet line of the fuel pump 460. Diesel flow rate control signals at given load and speed are provided by the ECU 960 to a flow control valve driver 520. The LPG and diesel are fumigated into air-fuel mixing chambers 560 and 740 at an engine intake manifold where air-fuel mixing takes place. Depending on the temperature of the engine intake air and the engine operating parameters such as load and speed, the ECU 960 provides control signals to the ultrasonic atomizer system 540 and the electronic injector driver 720 so that the suitable diesel and LPG flow rates are maintained to achieve desired fuel reactivity while at the same time the ECU 960 also provides control signals for controlling EGR rate and EGR temperature and engine intake air temperature control. Combustion phasing control is achieved by varying proportions of fumigated fuels, the EGR rate, and the EGR temperature and additionally by controlling the engine intake air temperature.

### Advantages of the Present Invention

The main advantages of the present invention are:

The present invention can utilize low volatile fuel such as diesel in combination with another fuel for HCCI mode of combustion. Low volatile fuels are difficult to atomize and vaporize to form a homogeneous charge with engine intake air.

The present invention can use a combination of any two fuels, such as low volatile fuel with another fuel, which may be volatile fuel or which may be gaseous fuel, for homogeneous charge compression ignition mode of combustion. Combustion phasing control in homogeneous charge compression ignition mode of combustion is done by varying ratio of two such fuels and by varying EGR rate and EGR temperature and additionally by controlling engine intake air temperature.

1. A Dual Fumigation Homogeneous Charge Compression Ignition (DF-HCCI) Engine comprising:
an engine body;
at least one combustion chamber in said engine body having a piston reciprocating in a cylinder;
an engine intake air system to intake an air stream and deliver it to the at least one combustion chamber;
an engine exhaust system to direct exhaust gases from the at least one combustion chamber;
a first fuel delivery system to fumigate and supply a first fuel into the air stream; and
a second fuel delivery system to fumigate and supply a second fuel into the air stream, wherein the engine intake air system is adapted to form a homogeneous mixture of the air stream, the first fuel, and the second fuel for combustion in at least one combustion chamber.

2. The DF-HCCI engine as claimed in claim 1, wherein the first fuel delivery system comprises an ultrasonic atomizer for atomizing the first fuel having a low volatility and delivering the low volatility first fuel into said engine intake air system and the second fuel delivery system comprises an electronic injector or an ultrasonic atomizer or any fuel induction system for delivering a second fuel into said engine intake air system.

3. The DF-HCCI engine as claimed in claim 1, wherein the first fuel is a low volatile fuel such as diesel and the second fuel is a high volatile fuel or a gaseous fuel.

4. The DF-HCCI engine as claimed in claim 1, wherein the first fuel and the second fuel are supplied into the air stream at a same time or at predefined timings to form the homogeneous mixture.

5. The DF-HCCI engine as claimed in claim 1, wherein the engine intake air system comprises an intake air heating system to control temperature of the air stream by utilizing heat from exhaust gas and/or the DF-HCCI engine.

6. The DF-HCCI engine as claimed in claim 1, further comprising:
an engine exhaust system to guide exhaust gases from the at least one combustion chamber.

7. The DF-HCCI engine as claimed in claim 1, further comprising:
an exhaust gas recirculation (EGR) system to recirculate a portion of engine exhaust gas, wherein the EGR system comprises:
an EGR flow control valve in communication with a flow control valve driver to regulate flow rate of an exhaust gas into the air stream; and
an EGR coolant fluid flow control valve in communication with a fluid flow control valve driver to control temperature of the EGR flowing through an EGR heating unit.

8. The DF-HCCI engine as claimed in claim 1, further comprising:
an electronic control unit to receive inputs from a plurality of sensors and transmit control signals to control fuel flow rate, EGR rate, EGR temperature, and air stream temperature.

9. The DF-HCCI engine as claimed in claim 8, wherein the plurality of sensors comprises one or more of temperature sensors, engine speed sensors, engine shaft crank angle sensors, and engine load sensors.

10. The DF-HCCI engine as claimed in claim 1, wherein the DF-HCCI engine is adapted to control a combustion phase at least by varying proportions of the first fuel, the second fuel, an EGR rate, an EGR temperature, and an air stream temperature.

11. A method to operate Dual Fumigation Homogeneous Charge Compression Ignition (DF-HCCI) Engine, the method comprising:
supplying an air stream for combustion using an engine intake air system;
fumigating and supplying a first fuel and a second fuel into the air stream using a first fuel delivery system and a second fuel delivery system respectively;
mixing the air stream, the first fuel, and the second fuel to form a homogeneous mixture; and
supplying the homogeneous mixture to at least one combustion chamber for combustion.

12. The method as claimed in claim 11, further comprising:
controlling supply of the first fuel and the second fuel based at least on an engine load and an engine speed in order to achieve required combustion timing in a combustion phase;
controlling an EGR rate and an EGR temperature based at least on the engine load and the engine speed; and
heating the air stream to a required temperature using an intake air heating apparatus.
